(19) United States
(12) Patent Application Publication
(10) Pub. No.: US 2020/0262648 A1
(43) Pub. Date: Aug. 20, 2020

(54) GARBAGE CAN WITH BAG REPLACEMENT MEANS

(71) Applicant: Mike Stanford, Mesquite, NV (US)

(72) Inventor: Mike Stanford, Mesquite, NV (US)

(21) Appl. No.: 16/866,323

(22) Filed: May 4, 2020

Related U.S. Application Data
(63) Continuation-in-part of application No. 15/635,172, filed on Jun. 27, 2017, now abandoned.

(51) Int. Cl. B65F 1/06

(52) U.S. Cl. CPC B65F 1/065; B65F 2210/179

(57) ABSTRACT

A garbage can having a vent disposed on, or near, a bottom surface, the air pump adapted to suck air from the garbage to position garbage bag in position within the garbage can. The pump may alternatively be used to push air into the garbage can to release the garbage bag.

### BACKGROUND OF THE INVENTION

### Field of the Invention

This invention relates to a garbage can and more particularly relates to a garbage can adapted to facilitate more efficient trash bag reception.

### Description of the Related Art

Garbage can and garbage bags are well known in the art. Garbage cans and waste containers of every size proliferate in residential, commercial and outdoor environments—public and private—forming receptacles for receiving waste. Polymeric bags, or trash liners, position within many garbage cans to receive trash, particularly those used in residential settings, often in kitchen areas. These bags are stretched around the rim of the garbage can and pulled from the garbage cans for disposal. Often the bags are used to store rotting perishable foods or food remnants. The bags are adapted to have watertight seams so that oils and liquids from these perishable materials do not fall into the garbage can itself or drain while the garbage bag is being transported. A consequence of this engineering is that garbage bags are also airtight. Being fabricated of flexible polymeric materials ensure that the bags are both watertight and airtight.

Because the bags are airtight, and stretched around the rim of the garbage can, the bags do not readily position within the garbage can itself when placed. Within the garbage can, air underneath the bag cannot escape as the bag is put into position, causing the bag to collapse when positioned rather than fall into place. As the garbage bag is pushed into the can, the air underneath the garbage bag becomes pressurized, collapsing the garbage bag. This is a problem unremedied in the art.

It can also be difficult to remove garbage bags which are full when the bag forms an airtight seal with the interior of the garbage can, created a vacuum underneath the garbage bag as it is removed.

Thus, it is desirable to provide a garbage can which is adapted to prevent this problem.

### SUMMARY OF THE INVENTION

From the foregoing discussion, it should be apparent that a need exists for a garbage can with bag replacement means. Beneficially, such a system would overcome many of the difficulties of the prior art by providing a garbage can which eliminates the problems of pressurized ambient air obstructing insertion and removal of the garbage bag.

The present invention has been developed in response to the present state of the art, and in particular, in response to the problems and needs in the art that have not yet been fully solved by currently available apparati and methods. Accordingly, the present invention has been developed to provide a garbage can comprising: a concave receptacle adapted to store waste, the receptacle having a substantially planar bottom surface, the planar bottom surface defining one or more bores through which air may travel; a shroud inferiorly circumscribing the planar bottom surface, the shroud defining an air vent; a pump disposed beneath the planar bottom surface, the pump affixed to one of the shroud and the planar bottom surface; a switch in electrical connectivity with the pump, the pump adapted to pull air from the garbage can in response to the switch being activated.

The switch may be activated to push air into the garbage can using the pump, wherein the pump sucks ambient air through the air vent.

The bore and pump may be interconnected using conduit in some embodiments. The apparatus may further comprise a power supply housed within the shroud.

A second garbage can is provided comprising: a concave receptacle adapted to store waste, the receptacle having a substantially planar bottom surface, the planar bottom surface defining one or more bores through which air may travel; a pump disposed beneath the planar bottom surface, the pump affixed to one of the shroud and the planar bottom surface; a switch in electrical connectivity with the pump, the pump adapted to pull air from the garbage can in response to the switch being activated.

A third garbage can is provided consisting of: a concave cubic receptacle adapted to store waste, the receptacle having a substantially planar bottom surface, the planar bottom surface defining one or more bores through which air may travel; an air pump disposed beneath the planar bottom surface; and a switch in electrical connectivity with the air pump, the air pump adapted to pull air from the garbage can in response to the switch being activated; a power supply.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a lower perspective view of a garbage can assembly with bag replacement means in accordance with the present invention;

FIG. 2 is a sectioned side perspective view of a garbage can assembly with bag replacement means in accordance with the present invention;

FIG. 3 is a sectioned isometric perspective view of a garbage can assembly in a relaxed/collapsed configuration with bag replacement means in accordance with the present invention; and

FIG. 4 is a sectioned isometric perspective view of a garbage can assembly in an expanded configuration with bag replacement means in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

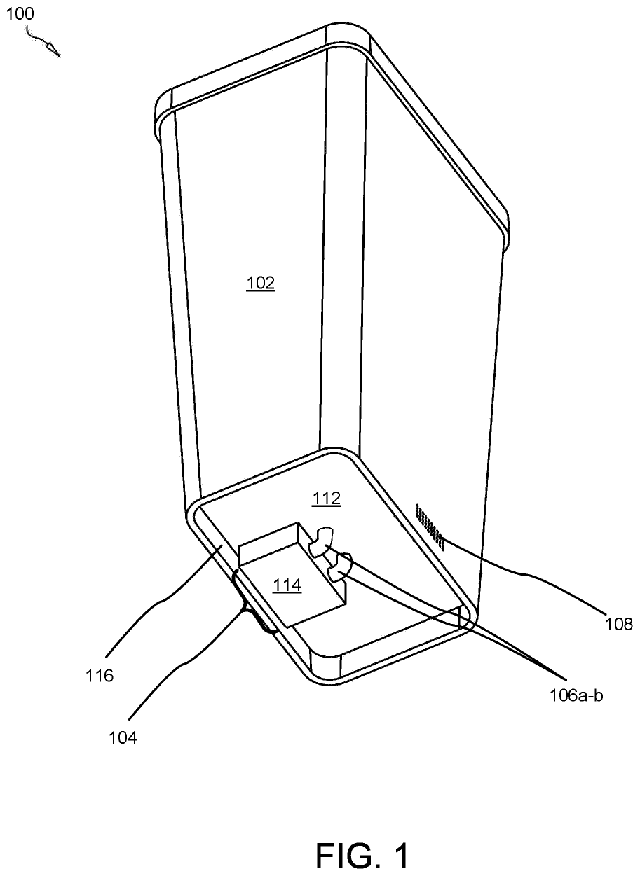

FIG. 1 is a lower perspective view of a garbage can assembly with bag replacement means 100 in accordance with the present invention.

The assembly 100 comprises a garbage can 102 having one or more air intake vents disposed on, or around, a planar bottom surface 112 of the garbage can 102. In the preferred embodiment, the vents are disposed centrically on a planar bottom surface 112 of the can (or a slightly concave bottom surface).

The vents conduct air to a pump 114 using tubular components 106 as known to those of skill in the art (or conduits). In some embodiments, the pump 114 is directly affixed centrically to the planar bottom surface 112 such that the tubular components 106 are not necessary.

In various embodiments, the planar bottom surface 112 is elevated above a ground surface or subgrade upon which the garbage can 102 rests. In these embodiments, the planar bottom surface 112 may rest above a shroud 116 which circumscribes inferiorly the base of the garbage can 102. The shroud 116 may define one or more air outtake vents 108.

The pump 114 may be affixed to the underside of the planar bottom surface, to the shroud, or interiorly or exteriorly to garbage can 102 itself. In the shown embodiments, the vent 108 comprises a plurality of parallel vertically-oriented slots.

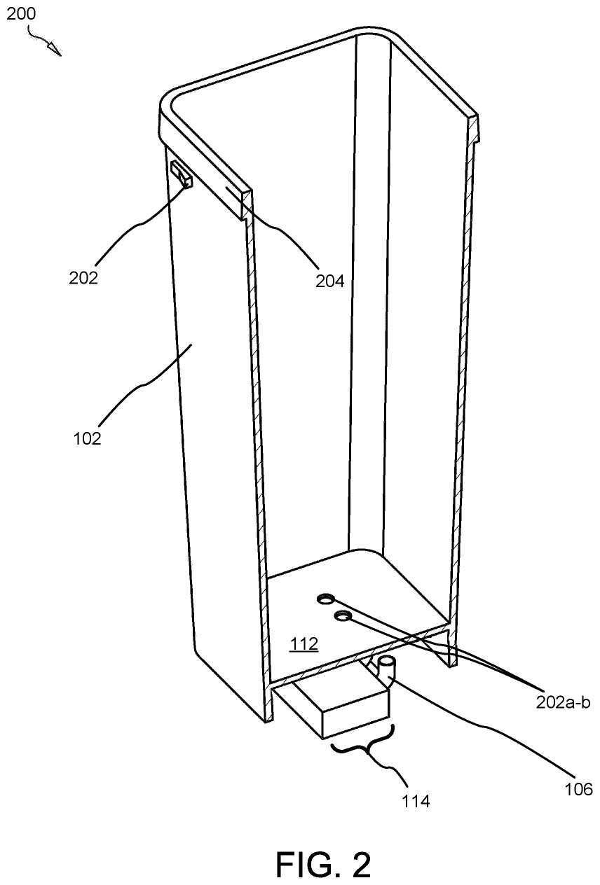

FIG. 2 is a sectioned side perspective view of a garbage can assembly with bag replacement means 200 in accordance with the present invention.

The vents are indicated at 202. In the shown embodiment, the planar bottom surface 112 defines two vents 202a-b through which air is sucked from the garbage can 102 by the pump 114.

The pump 114 may be switched on using a switch 202 positioned just under the rim 204 of the garbage can 102. In various embodiments, the switch 202 is in electrical connectivity with the pump 114 using conductive cable or wire. In some embodiments, the garbage can 102 is manufactured as an integrated product with the pump 114 and the switch 202. In other embodiments, the cable is strung inside or outside the garbage can 102 aftermarket. In other words, the pump 114 and switch may be sold as an aftermarket embodiment for affixation to a standard garbage can 102.

When the pump 114 is switched on the pump 114 removes pressurized ambient air from beneath a garbage bag and sucks the garbage bag into position in the garbage can 102. The pump 114 may also be reversed, to push air into the garbage can 102 to help a user remove a garbage bag, which can become difficult to remove when full as the bag may form an airtight seal with the interior sidewalls of the garbage can 102.

Two vents 202 are shown centrally-disposed, but a plurality of vents may be spread across the planar bottom surface 112 of the garbage can 200. Additionally, or alternatively, the vents may be disposed on the side walls of the garbage can 200 within 12 inches of the planar bottom surface 112.

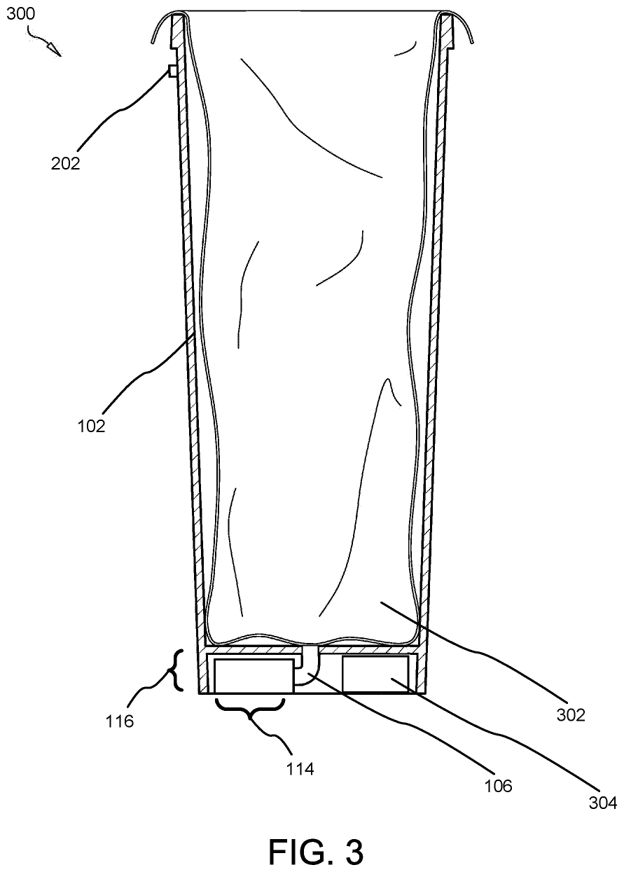

FIG. 3 is a sectioned isometric perspective view of a garbage can assembly in a relaxed/collapsed configuration 300 with bag replacement means in accordance with the present invention.

The garbage bag 302 is not fully pulled into position within the garbage can 102 because the pump 114 has not been switched on. The garbage can 300 may also comprise a power supply 304, in this case a battery or set of batteries. In other embodiments, the power supply interconnects with a 110 volt or other standard sized electrical outlet.

In various embodiments, the switch 202 is disposed near the bottom of the garbage can. The switch 202 may be affixed to the shroud 116. In various embodiments, the switch 202 may comprise a depressible foot pedal.

The conduits 106 may be housed interiorly to the shroud 116 or alternatively may circumscribe are be positioned exteriorly to the shroud 116.

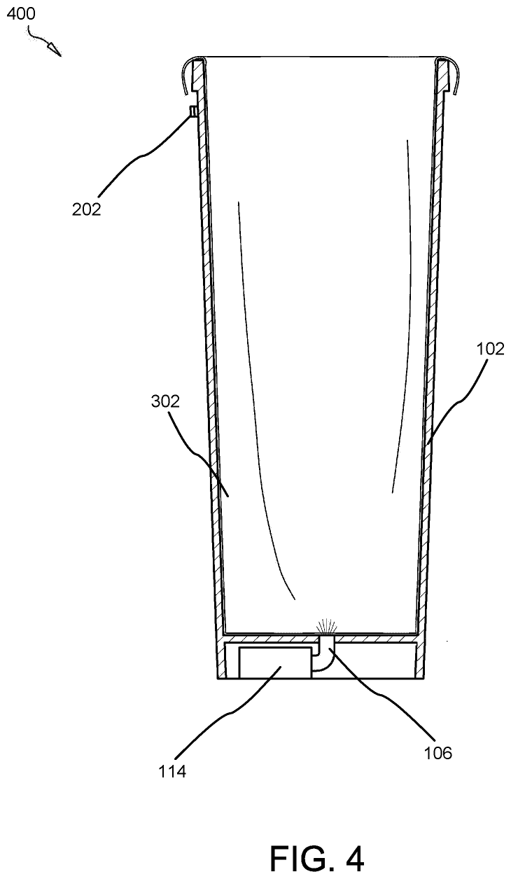

FIG. 4 is a sectioned isometric perspective view of a garbage can assembly in an expanded configuration 400 with bag replacement means in accordance with the present invention.

In this embodiment, the garbage bag 302 has been sucked into position by the pump 114 such that the garbage bag 302 is contouring the interior of the garbage can 102.

The apparati 100-400 may comprise of consist of all of the previously indicated components.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A garbage can comprising:
a concave receptacle adapted to store waste, the receptacle having a substantially planar bottom surface, the planar bottom surface defining one or more bores through which air may travel;
a shroud inferiorly circumscribing the planar bottom surface, the shroud defining an air vent;
a pump disposed beneath the planar bottom surface, the pump affixed to one of the shroud and the planar bottom surface;
a switch in electrical connectivity with the pump, the pump adapted to pull air from the garbage can in response to the switch being activated.

2. The garbage can of claim 1, wherein the switch may be activated to push air into the garbage can using the pump, wherein the pump sucks ambient air through the air vent.

3. The apparatus of claim 1, wherein the bore and pump are interconnecting using conduit.

4. The apparatus of claim 1, further comprising a power supply housed within the shroud.

5. A garbage can comprising:
a concave receptacle adapted to store waste, the receptacle having a substantially planar bottom surface, the planar bottom surface defining one or more bores through which air may travel;
a pump disposed beneath the planar bottom surface, the pump affixed to one of the shroud and the planar bottom surface;
a switch in electrical connectivity with the pump, the pump adapted to pull air from the garbage can in response to the switch being activated.

6. A garbage can consisting of:
a concave cubic receptacle adapted to store waste, the receptacle having a substantially planar bottom surface, the planar bottom surface defining one or more bores through which air may travel;
an air pump disposed beneath the planar bottom surface; and
a switch in electrical connectivity with the air pump, the air pump adapted to pull air from the garbage can in response to the switch being activated;
a power supply.
